(19) United States
(12) Patent Application Publication
(10) Pub. No.: US 2015/0039334 A1
(43) Pub. Date: Feb. 5, 2015

(54) CLAIM-CENTRIC GROUPER ANALYSIS

(71) Applicant: Optum, Inc., Minnetonka, MN (US)

(72) Inventors: Jean de Traversay, Solana Beach, CA (US); Yuriy Glagovskiy, Verona, NJ (US); Jeremy Hill, Chanhassen, MN (US); Opoku Adu-Gyamfi, Becker, MN (US)

(21) Appl. No.: 14/449,461

(22) Filed: Aug. 1, 2014

Related U.S. Application Data
(60) Provisional application No. 61/861,751, filed on Aug. 2, 2013.
(60) Provisional application No. 61/861,742, filed on Aug. 2, 2013.

(51) Int. Cl. G06Q 10/06; G06Q 50/22

(52) U.S. Cl. CPC G06Q 10/06395; G06Q 50/22
USPC 705/2

(57) ABSTRACT

Computer implemented systems and methods of health care claim analysis are provided by storing a claim data set in a computer database, including patient information and a DRG assignment based on at least a primary diagnosis code and one or more associated procedure codes. A nominal DRG weight is determined for the claim data set, using a processor in communication with the computer database. The processor looks up an alternate procedure code in the database, and determines an alternate DRG weight for the claim data set by swapping the associated procedure code with the alternate procedure code. A claim score is output to a user interface in communication with the processor, based at least in part on a difference between the nominal and alternate DRG weights.

### CROSS-REFERENCE TO RELATED APPLICATIONS

This application claims priority to U.S. Provisional Application No. 61/861,751, CLAIM-CENTRIC GROUPER ANALYSIS, filed Aug. 2, 2013, and to U.S. Provisional Application No. 61/861,742, CLAIM-CENTRIC GROUPER ANALYSIS, filed Aug. 2, 2013, each of which is incorporated by reference herein, in the entirety and for all purposes. This application is related to copending U.S. patent application Ser. No. ______, by Jean De Traversay, entitled CLAIM-CENTRIC GROUPER ANALYSIS [attorney docket number P239421.US.02], filed on even date herewith, which is incorporated by reference herein, in the entirety and for all purposes.

### BACKGROUND

This disclosure relates generally to health care claim processing, and specifically to claim-centric processing techniques for improved health care quality and effectiveness. In particular, the disclosure relates to claim-centric analysis techniques applicable to diagnosis-related groups (DRGs), designed to improve classification accuracy, provide more appropriate grouping, and ensure health care quality. The disclosure also concerns prevention of overpayments due to either intentional or non-intentional miscoding of claim elements, e.g. to prevent errors, fraud, waste and abuse.

Historically, health care costs were traditionally based on a service provided or fee basis, but since the end of the twentieth century grouper systems have been utilized to organize claim data into groups corresponding to particular diagnoses and related treatments. In particular, diagnosis-related group (DRG) based classification schemes were originally proposed by the Health Care Financing Administration (HCFA) in the 1980's, and are now widely utilized by the successor agency, the Centers for Medicare & Medicaid Services (CMS).

Essentially, the DRG system categorizes or codes patient services into diagnosis related groups, where each DRG code has an assigned payment weight based on the average cost of treatment, and the typical resources used to treat the associated condition. In particular, DRG-based systems are commonly used to determine reimbursement for hospital (inpatient) and other treatments, utilizing claim data including diagnosis and procedure codes, and patient information such as age, gender, and discharge status.

In the more elaborate Medicare severity diagnosis related group (MS-DRG) system, complication/comorbidity and major complication/comorbidity (CC/MCC) factors are also taken into consideration to account for the additional complexity of treatment due to patient severity. Payments are determined by the relative weights associated with the resulting MS-DRG grouping, and adjusted based on a wage index determined for the treatment location. Additional adjustments (e.g., cost of living, etc.) may also be made.

Thus, DRG codes are among a class of coding systems that bundle payment, avoiding over-inflation by focusing the gestalt or the whole of the claim based on the main characteristics of the episode, rather than the sum of its parts or an abundance of line items. The principles applied here are also applicable to other billing, coding and prospective payment systems, including those based on patient assessments and other payment bases.

Diagnosis related groupings are ubiquitous in the inpatient prospective payment system (IPPS) for Medicare patients. In this system, a particular DRG or MS-DRG is assigned to each in-patient stay or course of treatment, utilizing claim data including a principal or primary diagnosis code and a number of secondary diagnose codes, along with corresponding procedure codes and patient information including age, gender and discharge status. Derived data such as length of stay are commonly included.

The diagnosis codes are used first by a DRG or other grouper algorithm whose decision hierarchy thus begins with the election of a major diagnostic category (MDC), a categorization determined by the affected organ system. A surgical or medical (non-surgical) selection is then next in the decision hierarchy. Of all the procedures used to treat the patient (if surgery did occur), the ones most significant to the MDC are then identified through the so-called surgical hierarchy. In the MS-DRG system, the characteristically multiple secondary diagnoses may also include various complicating or comorbid (CC) conditions, or major complication or comorbidity (MCC) factors, reflecting an increased relative level of severity of the patient condition.

Generally, in addition to the single primary diagnosis noted on the claim, a number of secondary diagnoses are also usually found. For transplant recipients and other resource-intensive patient groups, a “pre-MDC” categorization has been created that may rely on particular surgical procedures, rather than on the usual first DRG selection step through a diagnosis-based MDC assignment.

Other DRG-type systems are utilized to address pediatric patients and other non-Medicare populations, including all-patient (AP-DRG), refined (R-DRG) and all-patient refined (APR-DRG) grouper hierarchies. These other systems may also employ severity subclasses, for example in an all-payer, severity-adjusted (APS-DRG or APS-DRGS) model, which represents variations from the “classic” DRG grouper and MS-DRG severity structure used by CMS for Medicare inpatient reimbursement, while generalizing and enhancing the methodology for applicability to all-payer (non-Medicare) patient populations.

Other coding and billing systems are used for in-home health care provider services, with analogous classification schemes for outpatient care and other non-hospital clinical procedures. These other grouper systems include, for example, general and enhanced ambulatory patient groups (APGs), ambulatory surgical center (ASC) codes, and ambulatory payment classifications (APCs).

Many of these systems incorporate elements of the international statistical classification of diseases and related health problems (ICD), a symptom-based medical classification system defined by the World Health Organization (WHO). ICD-based classification schemes may also account for a range of additional factors, including abnormal findings, patient complaints, social circumstances, and external causes of injury or disease. The ICD classification is adapted to allow DRG-type groupers to work with sufficiently granular (specific) diagnosis and procedure codes, leading to the CM (clinical modification) of the ICD system, specifically for the US DRG-based payment systems.

A wide variety of different grouper systems and coding hierarchies may thus be utilized to classify medical services, depending on patient population, location, and type of care provided. In each of these grouper systems, coding practices are in a continual state of development, in order to improve patient care and increase efficiency, while accommodating the constantly evolving landscape of international, federal, state and local regulations.

As a result, claims processing technologies must also constantly adapt, in order to provide effective management and tracking of coding data and other claim information. At the same time, more advanced, claim-centric techniques are also desired, in order to ensure appropriate grouping and improve classification accuracy, while promoting the highest levels of quality and efficiency for hospital care and other medical services.

### SUMMARY

This disclosure is directed to health care claim data analysis. Claim data sets are stored in a computer database, including patient information and DRG assignment or related diagnosis group data. The diagnostic group data may include a primary diagnosis code, one or more secondary diagnosis codes, and procedure codes, making up a set of claim data corresponding to each coded claim. Diagnoses, e.g. the primary diagnosis along with any or all available secondary diagnoses, and any or all available procedures can be included along with any additional DRG grouper-type elements such as the discharge status, the patient's age and gender.

A computer processor is provided in communication with database, with one or more program modules for analyzing the claim data. A DRG-derived or nominal relative weight is generated for each claim in the data set, based on the patient information in combination with the primary and secondary diagnosis codes. One or more alternate weights are determined for a given claim by swapping the primary and secondary diagnosis codes, using the secondary diagnosis code in place of the primary diagnosis code and the primary diagnosis code in place of the secondary diagnosis code.

Alternate procedure codes can also be identified as closely related to the procedures already coded on the claim, but which sometimes replace them (e.g., accidentally), for example using the coding scheme and grouper hierarchy to identify alternate diagnosis codes associated with the different procedure codes. In this approach, alternate DRG-type weights are determined by swapping the grouper-significant procedure code with a related procedure code, as identified by re-running the grouper with the alternate procedure in place of the one that was originally coded. Additional refinements can take into consideration potential “updgrading” of a complication/comorbidity coding, and using derived data such as the observed length of stay.

Claim scoring can be generated for each claim in the data set, and output to a user interface in communication with the computer processor. This transactional-based scoring technique has many operational advantages, is very intuitive and combines several features, thus preventing the complicated prioritization of multiple detection queues, and also allowing for precise control of the review capacity.

The claim score can be based on one or more of several different features, including the difference or drop in the claim (or DRG) weight, as defined between the nominal DRG weight (using the original claim data), and the alternate weights (obtained by swapping the different diagnoses and procedures). Other features can include elements of the length of stay or the complication/comorbidity analysis.

Generally, each claim score will have one or more of several contributing features, for example based on the relative impact of the different analysis modules or pattern detectors in the final risk score (or claim score). The level of contribution of each feature depends on how its measurement comes up, for the given claim being scored. This contribution level of all the features used in the score can actually be represented as the different reasons for the claim scoring as high, or low, for example in a ranked order based on relative contribution. Such scoring reasons contribute to end-user understanding of why a claim scored the way it did.

### BRIEF DESCRIPTION OF THE DRAWINGS

FIG. 1 is a block diagram of a representative computer based method for claim-centric grouper analysis.

FIG. 2 is a block diagram of a representative computer based system for claim-centric grouper analysis.

FIG. 3 is an excerpt from a representative coding scheme for grouping claim data.

FIG. 4 is a representative set of coded claim elements.

FIG. 5 is a representative sample of a report summary for a coded set of claim data.

FIG. 6 is a block diagram illustrating a generalized claim scoring procedure, for application to coded sets of claim data.

FIG. 7 is a schematic diagram of a representative compression network for use in claim-centric grouper analysis.

FIG. 8 is a schematic diagram of another representative compression network for use in claim-centric grouper analysis.

FIG. 9 is a histogram showing the results of a perturbation-based claim-centric grouper analysis for representative claims related to the heart failure and shock DRG.

### DETAILED DESCRIPTION

Diagnosis-related payment systems are ubiquitous in the health care industry, and international in scope. DRG and MS-DRG type claim systems are utilized not only in the United States, but also in Canada, Britain, France, Australia, South Africa, Chile, Ghana, and other nations. Although these individual systems can be locally modified, however, basic principles of the grouper logic remain substantially the same, across a wide range of different diagnosis and procedure coding schemes.

The methods articulated here are applied to the core principles of DRG, MS-DRG and other types of grouper logic, aiming to detect weaknesses that can lead to inaccurate coding, inappropriate care, and fraud. These methods are claim-centric, allowing them to be inserted into pre-payment positions within the claims processing stream, and applied to coded claim data on a post-adjudication, claim-by-claim basis. The design works equally well in a pre-adjudication setting, should the processing constraints allow the application to be installed there instead.

Similar analysis elements may also be applied to non-DRG based payment systems, for example to track the case mix at different entity levels. The grouper machinery (or grouper logic) from a range of different grouper systems can thus be used, in order to navigate the relevant revenue code lines, identify more optimal claim coding, and ensure an appropriate level of patient care.

The goals of the analysis include, but are not limited to:
Identifying more appropriate or accurate codes (e.g., DRG or MS-DRG) than were originally assigned to given claims, particularly where the alternate codes can be associated with more appropriate patient care, and a more suitable payment scale.
Identifying diagnosis codes, procedures, complication/comorbidity factors, length of stay and other elements in the original claim data, which may correlate with inappropriate coding and other (known or unknown) weaknesses in the grouper logic.
Identifying diagnosis codes, procedures, complication/comorbidity factors, length of stay and other elements that are not present in the original claim data, which may be missing, switched, replaced or omitted, and which may correlate with inappropriate coding and other (known or unknown) weaknesses in the grouper logic.
Identifying diagnosis codes, procedures, complication/comorbidity factors, length of stay and other elements in the original claim data, which do not suitably align with or correlate to other claim elements in the context of an original (e.g., DRG or MS-DRG) coding, and which may more suitably align with an alternate or more optimal coding.

To address these issues, a range of different analysis techniques are described. In particular, these include computer based methods and systems for claim-centric or claim-based grouper analysis, using multiple pattern detectors and analysis modules to generate a consolidated risk-based claim rating or score, along with a series of rationales describing the scoring basis for use in further (downstream) analysis.

The risk scoring may utilize a compression network, as described below. Other scoring methods may also be used, but this approach has properties that make it well suited (handling rich interactions of input features and, yet, still easy to reverse into the score reasons), and it has some unusual properties rarely found in other methods (tackles the horseshoe/donut problem; i.e., finding outliers in empty centroid space). A variety of smoothing and noise-prevention techniques may also be used, in order to pick out strong signals from the background noise.

These techniques also provide ease of transfer for the machinery to any other DRG-type grouper, including ones based on ICD-10 and ICD-11, and other revisions of the International Statistical Classification of Diseases and Related Health Problems (ICD). They may also be applied as a “countermeasure” to inappropriate use of DRG optimizer tools and software, including personal computer (PC) based systems that can be utilized to drive up costs (and payments), without providing better or more appropriate care.

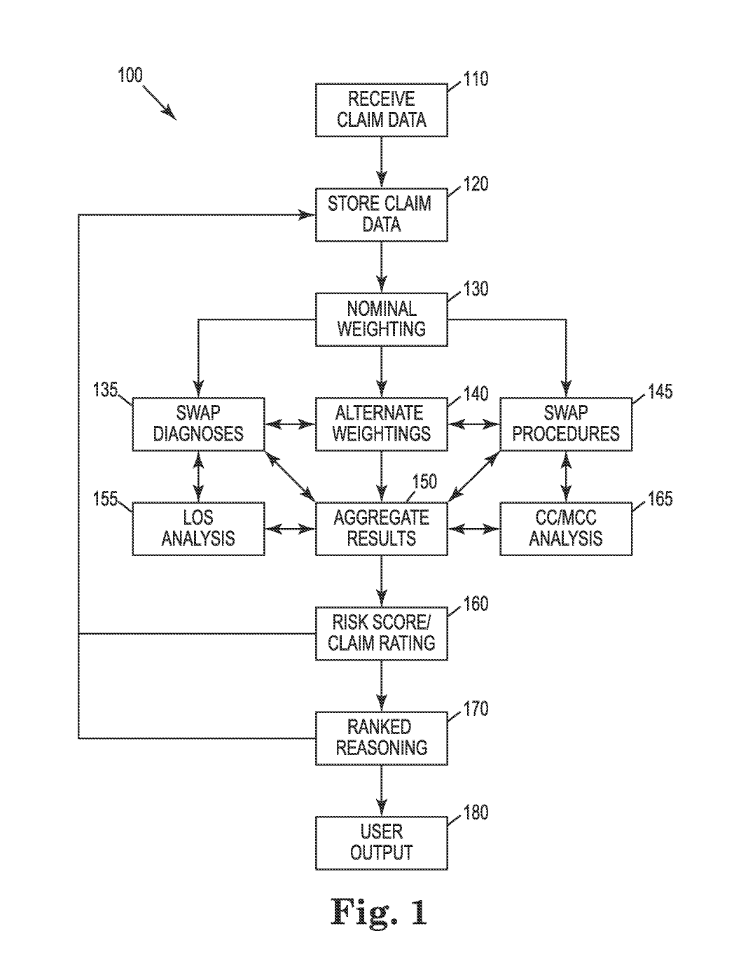

FIG. 1 is a block diagram of a representative computer based method 100 for claim-centric or claim-based grouper analysis. As shown in FIG. 1, method 100 includes one or more steps of receiving claim data sets (step 110), storing the claim data (120), generating a nominal DRG weight for each claim data set (step 130), generating alternate DRG weights (step 140) for the claim data sets, and aggregating the results (step 150) for each claim data set to generate a claim score (step 160), which may be combined with a set of ranked score reasons (step 170) for output to a user interface (step 180).

Depending on embodiment, method 100 may also encompass one or more additional steps including, but not limited to, swapping primary and secondary diagnosis codes (step 135), swapping procedure codes (step 145), length of stay analysis (step 155), and complication/comorbidity analysis (step 165). More generally, depending upon application method 100 may include any one or more of the above steps, where each selected step may be performed one or more times, in any order or combination.

Receiving claim data (step 110) is typically performed by a server or other networked computer system, but other methods such as hand entry, fax, email and voice communications are also contemplated. The claim data are typically generated by various coders, billing agents, health care workers and computer systems, for a service provided such as a hospital, clinic, pharmacy, lab, or other health care facility.

Storing the claim data (step 120) is typically performed using a database system with a combination of volatile and non-volatile memory components configured for secure data storage. The claim data are arranged into groups or sets, each corresponding to an individual claim that has been submitted for payment or processing. Each claim or set of claim data, in turn, should represent actual services provided to a patient, for treatment of a disease or condition based on the corresponding diagnosis.

Typically, each set of claim data will thus include both patient information and diagnosis group data related to health care services provided to that patient, for example during a hospital stay or in the course of a clinical procedure, in order to treat the disease or condition associated with the diagnosis coding. The patient information may include the age and gender of the patient, along with discharge status and derived information such as length of stay. Additional patient information may also be provided, for example patient name, address, and health care plan and coverage information, or a patient identifier associated with such information.

The diagnosis group data include at least a primary diagnosis code, which identifies the principal or main reason for treatment. In particular, the primary diagnosis code identifies the condition established after study to be chiefly responsible for admission of the patient to the hospital for inpatient care, or for other (e.g., outpatient or ambulatory) care.

While the primary diagnosis code represents the main reason for a particular hospital stay or treatment, it may not necessarily be the patient's most life-threatening condition, or even the diagnosis responsible for the greatest length of stay or consumption of resources. The primary diagnosis code may also reflect clinical findings and other information discovered during treatment, and thus may differ from the admitting diagnosis code.

Coding professionals should ensure that code assignments are based on medical record documentation by licensed practitioners or staff authorized to write in the chart, and diagnoses should be supported by physician/provider documentation. The Uniform Hospital Discharge Data Set (UHDDS) defines principal diagnosis as the condition established after study to be chiefly responsible for occasioning the admission of the patient to the hospital for care. This definition should be “ingrained” in coders' minds and applied as they go through the record, stressing the importance of the key words after study. It is not the admitting diagnosis but rather the diagnosis found after workup or even after surgery that proves to be the reason for the admission. Principal diagnosis is not just what got the patient off of the couch.

One or more secondary (or other) diagnosis codes may also be provided. Secondary and other diagnosis codes include conditions that coexist at the time of inpatient admission or ambulatory service, or develop subsequently, which affect either the treatment received or the length of stay.

Sequencing diagnoses that qualify as principal circumstances of an inpatient admission typically govern the selection of a principal diagnosis. When two conditions are interrelated, with each potentially meeting the definition for principal diagnosis, coders may sequence either condition first, unless the circumstances of the admission, the therapy provided, the tabular list and/or the alphabetical index indicate otherwise.

If the physician's diagnostic statement identifies a symptom followed by contrasting/comparative diagnoses, official ICD-9-CM Coding Guidelines state that coders should sequence the symptom first as the principal diagnosis. “In those rare instances when two or more contrasting or comparative diagnoses are documented as ‘either/or’ (or similar terminology), they are coded as if the diagnoses were confirmed and the diagnoses are sequenced according to the circumstances of the admission. If, at time of discharge from the hospital or other facility, the diagnosis remains uncertain (documented with words like probable, suspected, likely, questionable, possible, still to be ruled out, etc.), the condition gets coded “as if it existed or was established.”

Diagnoses that relate only to an earlier episode are typically excluded, where they have no acute bearing on the current treatment or hospital stay, but other diagnoses that affect patient care are typically coded and included with the diagnosis group data. Secondary diagnoses are thus included with the claim data when they require clinical evaluation, diagnostic procedures, therapeutic treatment, or increased monitoring, care or length of stay. Depending on application, any or all of the secondary diagnoses may also include or carry along a “present on admission” indicator, to indicate whether the onset of the diagnosis preceded or followed admission to the hospital or clinic, since this indicator may affect payment.

Procedures listed on the claim can also contribute to the grouper logic, as they are related to care or treatment of the primary and secondary diagnoses. For example, a principal procedure code may be used to identify a definitive treatment related to the primary diagnosis, rather than, say, procedures performed for exploratory or additional diagnostic purposes. In some instances, additional procedure codes can also influence the grouper logic.

Typical surgical procedures include incision, excision, amputation, introduction, endoscopy, repair, destruction, suture, and manipulation. Additional significant procedures may also be coded, for example where necessary to address a complication, as well as procedures that carry a procedural or an anesthetic risk, or require specialized training.

Nominal weighting (step 130) is performed to determine the nominal DRG weight or other payment basis for a particular claim, based on the associated set of claim data. Generally, each code (e.g., DRG, MS-DRG or some other code type) is associated with a relative weight or payment weight. The relative weight represents an average resource consumption for patients with that condition, for example within a Medicare population, or other representative patient group.

Typically, the relative weight is multiplied by a base rate to determine payment. The base payment rate generally includes a labor-related share, which is adjusted by a wage index, and a non-labor related share. Additional adjustments can also be made, for example to compensate for the indirect costs of medical education (e.g., at teaching hospitals), or based on relative cost of living, characteristic of the patient population, cost outliers, and other (e.g., specialty, malpractice insurance protection, etc.) cost factors.

Alternate weighting (step 140) is performed to determine the effect of “tweaking” or perturbing the diagnosis part of the claim (or claim data), for example by swapping primary and secondary diagnosis codes (step 135), swapping procedure codes (step 145), or both. Length of stay (step 155) and complication/comorbidity analysis (step 165) may also be used, as described below.

The alternate weighing processes is utilized to determine whether a different (e.g., DRG, MS-DRG or some other DRG type) coding might have been more optimal or appropriate, given the actual patient condition and other claim data. In particular, more optimal codes are those that correlate with the most suitable diagnoses, procedures, and compensation, while ensuring the highest appropriate level of patient care.

When swapping diagnosis codes (step 135), an alternate (e.g., DRG) weight is determined for the claim by switching the primary (PDX) and secondary (SDX) diagnosis codes (e.g., with the computer processor). The coding algorithm or grouper logic is then re-applied, with the secondary diagnosis code (SDX) in place of the primary (PDX), and the primary diagnosis code (PDX) in place of the secondary (SDX), in order to determine the corresponding difference (drop or rise) in the nominal DRG weight (with original codes), as compared to the alternate DRG weight rating or score (with swapped codes).

Swapping procedure codes (step 145) is performed by identifying a primary or significant procedure code from among the procedures stored with the diagnosis group data, for example the most significant procedure within the major diagnostic category (which is, in turn, determined by the primary diagnosis on the claim). Generally, the most significant procedure code identifies a definitive treatment for the primary diagnosis, as described above, typically based on the grouper logic used to generate the original DRG assignments for the claim data. The original DRG assignments are also stored in the database.

Alternate procedure codes are then identified from the grouper logic stored in the database, for example where the alternate procedures are associated with different but closely related treatments or diagnosis codes. Where the same grouper logic used to assign DRGs to the claim data is also used to identify the alternate procedures and diagnosis codes, the alternate weights are identified on the same payment basis. Selecting procedures from the same grouper logic that was used to code the claim data also allows the application of new alternate procedure and diagnosis codes, which are not present in the original claim data; that is, the new, alternate procedures may be absent from the corresponding diagnosis group data that was originally provided, and only generated in the analysis stage. The original MDCs may also be reassigned, based on the alternate procedure codes.

When the diagnosis group data include more than one secondary diagnosis code, a series of alternate DRG weights can be determined by swapping the primary diagnosis code with each of the secondary diagnosis codes in series. Similarly, multiple procedures can also be swapped in an out, in order to perturb the data when both the primary and secondary diagnosis codes are in primary position. The corresponding drop (or rise) in the claim DRG weight is determined for each case, based on the difference between the nominal and alternate weightings. These differences are then aggregated (step 150), in order to generate the claim score (step 160).

The aggregated DRG weight drop can be adjusted for the number of alternate weightings (e.g., secondary diagnoses or procedure swaps, or both), for example using a mean or weighted mean. Alternately, an absolute sum or variance-based approach can be utilized, or the claim weight can be determined based on the largest rise or drop (or other identified change) in the nominal DRG weight, as compared to the alternate DRG weight.

The claim score (step 160) is generated partially based on the difference between the nominal and alternate DRG weights. Typically, a large difference or drop in the nominal weight may indicate a relatively higher level of risk that the coding was inaccurate or non-optimal. Thus, high-scoring claim data sets may be flagged for review, in order to determine whether the weight and payment accurately reflect the actual patient condition, as captured by the documentation of the patient's medical record, and indicate that an appropriate level of care was received, given the payment basis.

For procedure swapping, the claim score is generated partially based on the corresponding drops (or rises) in the claim weight, as determined between the nominal DRG weight based on the primary diagnosis code in the original claim data, and the alternate DRG weight based on an alternate diagnosis that is associated with the alternate (swapped-in) procedure, as selected from the grouper logic. A number of alternate codes can also be determined, with the results aggregated as described above (step 150). Results from diagnosis swapping (step 135) and procedure swapping (step 145) can also be combined in the aggregation step, for example by a sum or relative weighting across the different swaps, or by adjusting the claim score from one procedure based on results from the other.

While this analysis has applications in fraud detection, the overall goal of the CMS-defined DRG grouper logic is to improve patient care and outcomes, while making the best use of patient care resources. Thus, either a rise or drop in the alternate DRG weight (as compared to the nominal value) may impact the risk assessment score. In addition, the scoring scheme is designed to indicate claim reviews not only for accuracy and appropriateness of the coded claim data, but also to be sure that accurate diagnoses were made and appropriate care was provided, as indicated by the actual patient condition.

Relevant factors for risk scoring and claim rating include, but are not limited to:
Automated analytic exploration of the claim data, in order to identify “hot spots” associated with inappropriate treatment or inaccurate coding.
Unsupervised and supervised machine learning techniques to identify fraud, waste and abuse (FWA) in health care services.
Ideal scenarios for strong leveraging of rule-based and model-based detection for queue-based claim review, and staffing levels for development and maintenance.
Implementation based on ideal scenarios for real-world claim data comparisons.
Workflow considerations include careful positioning in claims processing stream, with appropriate handling of critical data elements for both retro-active claim validation and deployment for pre-payment (pre- and/or post-adjudication) claim analysis.
Deep drilling, wide-ranging analysis of DRG and MS-DRG type grouper logic, also applicable to non-DRG based claim processing.

A length of stay (LOS) analysis (step 155) can also be employed. Generally, the observed length of stay can be used to adjust the claim score or rating up or down, based on comparison to the average length of stay for the coded diagnoses. Gender, age, discharge status and other patient data can also be considered, using historical patient and provider information stored in the database.

Length of stay information can also be utilized to determine whether any of the alternate primary/secondary diagnosis code or procedure combinations would generate a more optimal match to the actual claim data, and used to increase or decrease the claim score accordingly. In particular, the observed length of stay can be compared to the average value for the secondary diagnoses, and for alternate diagnoses determined by swapping procedures. Length of stay information can also be used for scaling the corresponding alternate weights in the aggregated rating, where lengths of stay close to the historical mean for a particular diagnosis would typically result in a lower scaling, while lengths of stay substantially above (or below) the historical mean value would typically result in a higher scaling.

For complication and comorbidity analysis (step 165), different approaches are also possible. In one example, alternate claim weights are generated by swapping out the complication/comorbid or major complication/comorbid (CC/MCC) factors in the claim data, and aggregating the alternate weights into the final claim score. Again, reference to the same grouper logic that was used to code the claim data allows for alternate weighting based not only on the actual diagnosis, procedure, and comorbid/complication codes present in the original claim data, but also using additional codes that are identified based on the grouper logic, but are not necessarily present in the original claim data.

The alternate CC/MCC weights can also be scaled based on historical data stored in the database. For example, a higher score may be indicated when the historical data indicate a potential for clerical errors in the CC/MCC coding, or where inappropriate “upcoding” may be occurring, based on comparison to historical CC/MCC data for the same diagnosis codes (e.g., DRG or MS-DRG), on a provider-by-provider basis.

Typically, the claim rating is output to a user interface (step 180) for review. Additional information may also be provided, including a basis or rational for the claim score, for use in additional (e.g., post- or pre-adjudication) analysis. The score reasons (or rationales) are selected from one or more potential rating factors, or reasons for associating a given risk score to the claim. These factors include changes in the nominal DRG weight (or differences between the nominal and adjusted DRG weights) based on perturbations such as swapping and procedure codes or complication/comorbid factors, and adjustments based on comparisons between the observed length of stay and the historical average for the given primary and secondary diagnoses, as compared to the various alternatives identified using the grouper logic.

In some applications, the different rationales are ranked in the output (step 170), for example based on relative contribution to the claim score. Typically, both the claim rating and the reason data may also be stored in the database, together with the claim data. Alternatively, the claim data and output may be separately stored, for example to improve security, and an index, pointer, or other file indicator may be provided to link the two sets of data.

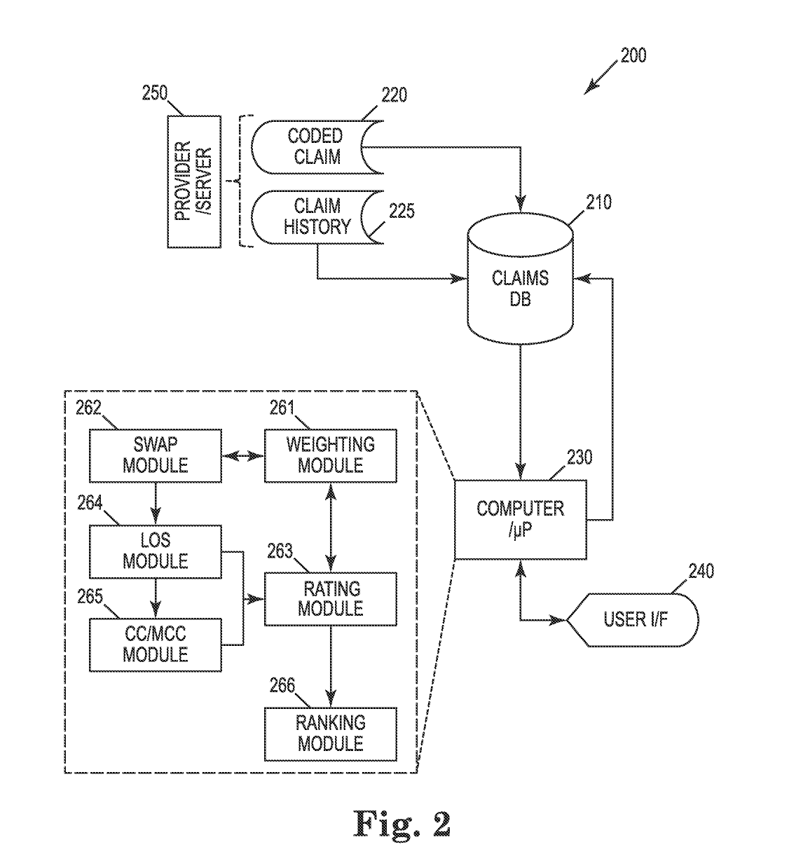

FIG. 2 is a block diagram of a representative computer-based system 200 for claim-centric grouper analysis. As shown in FIG. 2, system 200 includes a claims database 210 for storing coded claim data 220. Database 210 is provided in communication with a computer processing system or microprocessor (μW) 230, as configured for claim-by-claim grouper analysis, with user interface 240 for outputting claim ratings, ranked rationales, and other results.

Database 210 comprises a combination of volatile and non-volatile memory components configured for storing coded claim data sets 220 received from a provider, data server or other data source 250, for example as described in steps 110 and 120 of method 100, above. Claim data sets 220 include patient information with age, gender, discharge status and other patent data, and associated diagnosis group data with at least a primary diagnosis code and one or more secondary diagnosis codes and with some procedures codes depending on whether the claim includes a surgery or some form of procedural intervention.

Within coded claim data sets 220, the primary and secondary diagnosis codes are associated with the procedure codes and various complication/comorbid or major complication/comorbid (CC/MCC) factors based on a particular grouper logic or other coding scheme, as described above. In some applications, provider-based complication/comorbidity, length of stay and other claim history data 225 are also provided, and stored in claims database 210 for use in a corresponding LOS or CC/MCC analysis module, as described below.

Computer system (or processor) 230 is provided in data communication with database 210, for example using a secure local area network, internet, or cloud-based sever connection. The computer system includes a processor or microprocessor (μW) configured to generate a claim rating for each claim data set, based at least in part on a difference between the nominal claim DRG weight using the patient data in combination with the original primary and secondary diagnosis codes, and an alternate DRG weight based on swapping the primary and secondary diagnosis codes. Similarly, the alternate DRG weights are generated by swapping procedure codes or complication/comorbid (CC/MCC) factors, and the score may also be adjusted based on other CC/MCC or length of stay (LOS) analysis, as described herein.

To perform these analysis functions, computer/processor system 230 may utilize a number of individual program modules or software applications, which are executed to perform different processing steps on the claim data stored in database 210. As shown in FIG. 2, for example, DRG weighting module 261 is provided to generate nominal and alternate claim DRG weightings, for example as described in steps 130 and 140 of method 100, above. In addition, one or more swap modules 262 may also be provided, for example to generate the alternate claim DRG weightings by swapping primary and secondary diagnosis and procedure codes, as described in steps 135 and 145.

Ratings module 263 is executed to generate a claim rating or risk score for each claim data set, based at least in part on the differences between the nominal and alternate DRG weights. For example, ratings module 263 may utilize an aggregated difference or other measure to account for the number of primary/secondary diagnosis and related procedure swaps, as described above for aggregation step 150 and rating step 160 of method 100.

Rating module 263 can also be configured to adjust for other contributions to the claim score, including length of stay adjustments via LOS module 264 (see step 155), and complication/comorbidity adjustments via CC/MCC module 265 (see step 165). Output to user interface 240 (step 180) may include both the risk score from rating module 263 (see steps 150 and 160), as well as scoring rationale or other basis for the claim rating, for example using a ranking module 266 (step 170). Alternatively, the score defines a corresponding ordinality.

Generally speaking, the claim data analysis techniques of method 100 and system 200 can be substantially improved by access to the grouper architecture, as reflected in the source code used to generate the claim data. Cooperation with well-seasoned subject matter experts and experienced auditors is also valuable, particularly where this can help identify the grouper's weak spots. The knowledge base also includes thin slicing type approaches, where the results can be focused on a few relevant variables, without necessarily weighting all inputs equally.

To operate on an automated, claim-by-claim basis, however, the system must also utilize computer-based processing techniques, including sophisticated supervised and unsupervised machine learning techniques, as described herein. At the same time, machine processing techniques can also utilize ongoing input from savvy and seasoned subject matter experts, which can be utilized not only to address routine updates in the various coding systems, but also for broader issues related to software development and product life cycle, as expressed within the scope of subject matter encompassed by the appended claims.

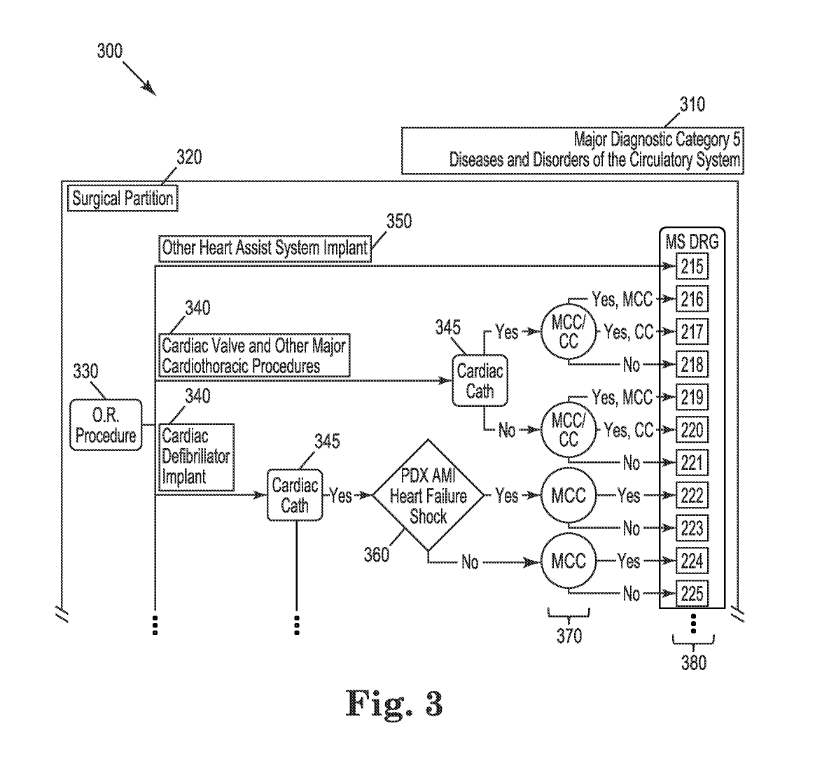

FIG. 3 is an excerpt from a representative grouper logic or coding scheme 300, which is used for grouping and coding claim data. As shown in FIG. 3, a major diagnostic category (MDC) 310 is selected, for example Diseases and Disorders of the Circulatory System (MDC-5). In this particular example, surgical partition 320 is also selected, but in general there will also be a medical partition option, and other partition hierarchies may also be used. Thus, the example of FIG. 3 is purely for illustrative purposes.

Within this particular major diagnostic category 310 and associated (surgical) partition 320, as shown in FIG. 3, a variety of different procedures may be selected, for example an operating room (O.R.) procedure 330 such as a cardiac defibrillator implant, cardiac valve, or other major cardiothoracic procedure 340, with (or without) a cardiac catheter 345, or a different heart assist system implant procedure 350. Depending upon patient condition, there may also be additional conditions or diagnoses 360, for example heart failure or shock. In addition, each of the coding branches may also have one or more different associated complication/comorbid factors 370, which are selected to determine the final (e.g., MS-DRG) code 380.

The available procedural and diagnosis codes typically depend upon the major diagnostic category and partition, or other coding hierarchy. In DRG and MS-DRG type systems, for example, additional MDC codes may include the Nervous System (MDC-1), Eye (MDC-2), Ear, Nose, Mouth and Throat (MDC-3), Respiratory System (MDC-4), Digestive System (MDC-6), Hepatobiliary System and Pancreas (MDC-7), Musculoskeletal System and Connective Tissue (MDC-8), Skin, Subcutaneous Tissue and Breast (MDC-9), Endocrine, Nutritional and Metabolic System (MDC-10), Kidney and Urinary Tract (MDC-11), Male Reproductive System (MDC-13), Female Reproductive System (MDC-14), Pregnancy, Childbirth and Puerperium (MDC-15), Newborn and Other Neonates, Perinatal Period (MDC-16), Blood and Blood Forming Organs and Immunological Disorders (MDC-16), Myeloproliferative Diseases and Disorders, Poorly Differentiated Neoplasms (MDC-17), Infectious and Parasitic Diseases and Disorders (MDC-18), Mental Diseases and Disorders (MDC-19), Alcohol/Drug Use or Induced Mental Disorders (MDC-20), Injuries, Poison and Toxic Effect of Drugs (MDC-21), Burns (MDC-22), Factors Influencing Health Status (MDC-23), Multiple Significant Trauma (MDC-24), or Human Immunodeficiency Virus Infection (MDC-25).

Alternatively, a “pre-MDC” code may be selected (MDC-0), for example to indicate a transplant, tracheostomy or other resource-intensive procedure. There are also DRG and MS-DRG type codes for procedures unrelated to the principal diagnosis, for invalid discharge diagnoses, and for “ungroupable” cases, which cannot be assigned to a valid DRG or MS-DRG type code.

Ambulatory and all-patient grouper or coding schemes may also be used, as described above, and all of these systems may evolve over time, as known to persons of ordinary skill in the art. Thus, the scope of the disclosure is not limited to any particular grouper logic, but encompasses any suitable claim coding system, including not only different versions of the various DRG and MS-DRG based groupers, but also other coding schemes for inpatient, outpatient, ambulatory, non-ambulatory, in-home, clinical, and pharmacological care, as known in the art, and as encompassed by the accompanying claims.

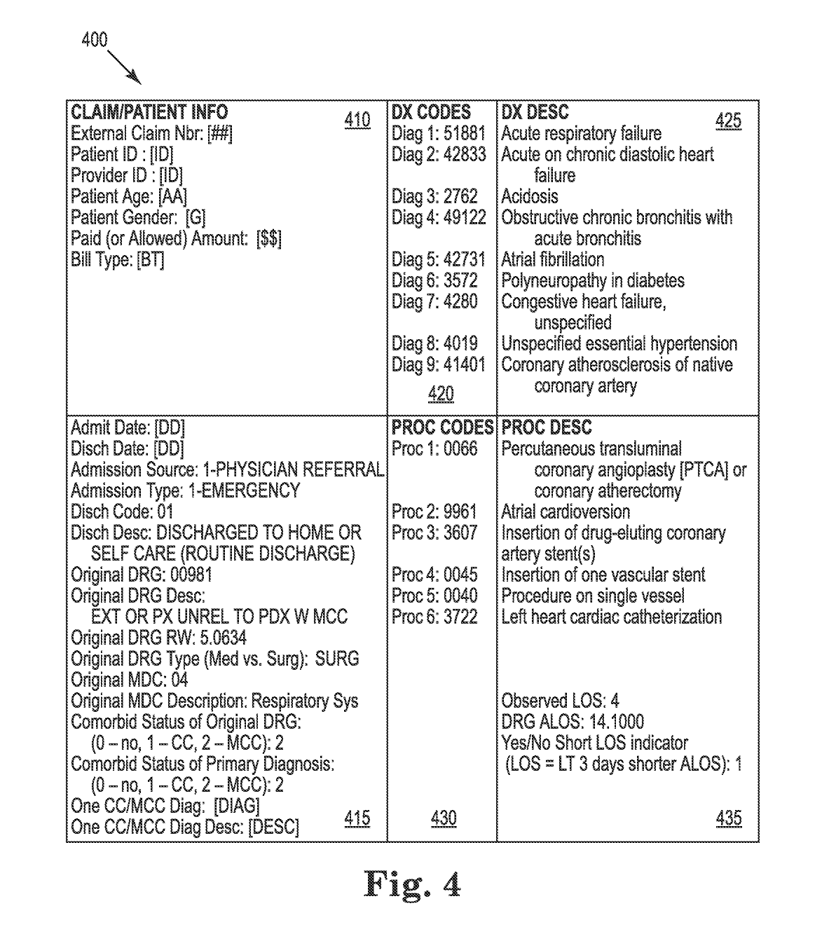

FIG. 4 is a representative set 400 of coded claim data, for example as generated by a particular grouper logic or coding scheme 300, and provided for input to a claim-based grouper analysis method 100 or system 200, as described above. In this particular example, claim data set 400 includes claim/patient information fields 410 and 415, diagnosis code and description fields 420 and 425, and procedure code and description fields 430 and 435, respectively.

In the patient information fields, representative information is indicated by placeholders in square brackets. The other codes, descriptions, and additional information fields in claim data 400 are merely exemplary, and vary from claim to claim depending upon diagnosis, treatment, and the selected coding scheme or grouper logic. In particular, while FIG. 4 may relate to a particular ICD version (e.g., ICD-9), this is merely representative. More generally, the techniques described herein are applicable to both older and newer ICD versions, including at least ICD-10, ICD-11 and future ICD-based grouper logics and coding schemes.

Patient information field 410 includes patient age and gender, and may include additional identifying information including, but not limited to, a claim number, patient and provider ID, bill type and payment amount. Supplemental patient information field 415 may include additional patient information including, but not limited to, admission and discharge information (date, source, type, and status), original grouping information (original DRG code description, relative weight, medical/surgical type, major diagnosis code and description), and complication/comorbidity data including the presence of complication/comorbid (CC) or major complication/comorbid (MCC) factors in the original DRG, and in the primary diagnosis.

Diagnostic field 420 includes at least a primary diagnosis code (Diag 1) and a number of secondary diagnosis codes (e.g., Diag 2 through Diag 9), as described in diagnosis description field 425. A number of corresponding procedure codes (e.g., Proc 1 through Proc 6) are provided in procedure code field 430, with corresponding descriptors in procedure description field 435. Additional diagnosis (DX) information can also be included in a case management tool, for example hospital acquired/present on arrival (HAC/POA) and complication/comorbidity (CC/MCC) data.

Additional (e.g., derived) information may also be provided, including the observed length of stay (LOS) based on admit and discharge dates (and time), average length of stay for a given coding (DRG ALOS), and a LOS indicator based on comparing the two values (e.g., a yes/no short LOS indicator). Alternatively, different data may also be provided, for example a long LOS indicator, or a scaled (continuous or non-binary) value that varies with the difference between the observed and average length of stay.

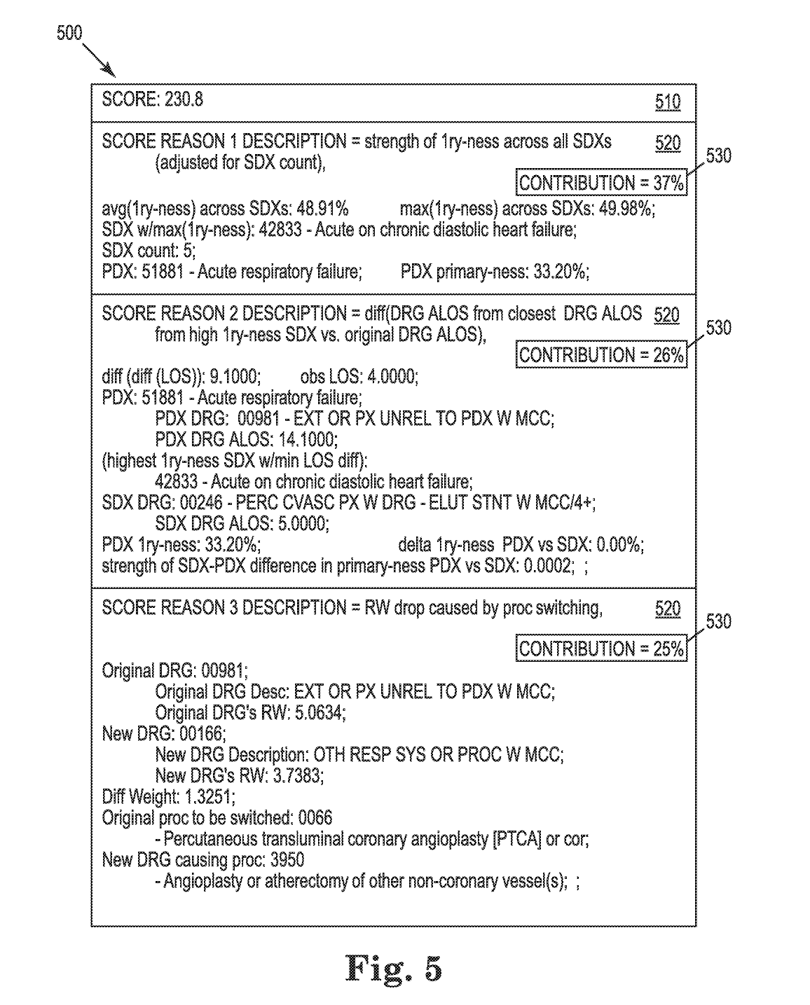

FIG. 5 is a representative sample of a report summary 500 for a set of coded claim data, for example claim data 400 as generated by some particular grouper logic 300, and as described with respect to FIG. 3 and FIG. 4, above. A number of such report summaries are contemplated, with different features and particular details as appropriate to the particular claim data being considered. Report summary 500 may be produced as output from a claim-centric grouper analysis technique, for example utilizing claim-centric grouper analysis method 100 of FIG. 1, or claim-centric grouper analysis system 200 of FIG. 2. FIGS. 4 and 5 may also represent elements of a case management tool designed for review work by end-users (e.g., claim and medical record reviewers).

As shown in FIG. 5, summary or output 500 includes claim rating or score field 510 for a given set of claim data, corresponding to a hospital stay or other course of treatment. In this particular example, the value of rating or score field 510 varies from 1 to 1000. Higher scores are designed to be more interesting for audit purposes, and can be flagged for further analysis of examination. Alternatively, a different scoring range may be used (e.g., 1 to 10 or 1 to 100), and higher, lower, or intermediate scores may indicate claims having a higher risk of inaccurate coding, inappropriate care, or fraud.

Claim summary or output 500 may also include one or more “score reason” or rationale fields 520, for example as presented in ranked order depending on relative contribution to the overall claim score, indicated in relative contribution fields 530. The particular contents of rationale or reason fields 520 thus vary, depending upon the nature of the most influential feature that caused the raising of the score or rating, and as expressed in the particular reasons for assigning an overall value to claim rating/risk score field 510, e.g., feature components displayed to contextualize what may have caused the feature to raise the score.

Where swapping primary and secondary diagnoses codes contribute substantially to the overall claim score, for example, a higher-ranked rationale field 520 may describe a “primary-ness” (or “lry-ness”) scoring algorithm, as shown in SCORE REASON 1 DESCRIPTION, toward the top of FIG. 5. This particular result is based on the notion of how frequently a diagnosis occurs in primary position, i.e. the primary-ness of a diagnosis, as is explained in detail below. The primary-ness for the actual primary diagnosis code (PDX) is compared to the average or highest primary-ness across all secondary diagnoses codes (SDX) in the claim data set, adjusted for secondary diagnosis count. Where the primary diagnosis has a substantially lower primary-ness than the average of the secondary diagnoses, this tends to increase the value of risk score field 510, through the corresponding value of relative contribution field 530.

A length of stay (LOS) analysis can also contribute to the claim rating, as indicated in the middle-ranked rational field 520 (SCORE REASON 2 DESCRIPTION). As a possible approach to leverage the nature of the LOS against which diagnosis should occur in primary position (given the influence of this primary position in determining the DRG), the average length of stay for the primary diagnosis code (PDX DRG ALOS) can be compared to the actual observed length of stay (obs LOS), and optionally to the average length of stay for one or more of the secondary diagnosis codes (SDX DRG ALOS). If, as shown here, the observed length of stay more closely matches that of a secondary diagnosis code, for example one with a high (or highest) “primary-ness” score (e.g., “high lry-ness SDX vs. original DRG ALOS”), this may also increase the value of risk score field 510, through the corresponding value of relative contribution field 530.

Procedure switching can also contribute to the claim rating, as shown in the lower-ranked rational field 520, SCORE REASON 3 DESCRIPTION, toward the bottom of FIG. 5. Here, the contributions to risk score field 510 is based on the relative weight of the original DRG (“Original DRG's RW”), as compared to that of a new or alternate DRG (“New DRG's RW”) produced by the also listed switched procedure, using a differential (“Diff Weight”) or other comparative measure.

Swapping out the procedure associated with the original DRG (“Original proc to be switched”), in favor of a new procedure that “causes” a new DRG (“New DRG causing proc”). Procedure switching, for the most part, is not necessarily coupled with causing a diagnosis switch, but the in some applications this may occur. Swapping the procedures can also affect the relationship with the primary and secondary procedures, as well as the average length of stay, all of which could significantly shift the claim DRG weight.

Complication/comorbidity (CC/MCC) factors can also be considered in the claim scoring, as described above. Thus, the process can be generalized to include an arbitrary number of different reasons for an individual score, as expressed in rationale or reason fields 520, where each relative contribution field 530 is based on the effect of a different software pattern recognition module or other computer-based analysis, as described below.

FIGS. 4 and 5 also illustrate the wide manner of information that can be provided in the (e.g., single-screen or one-page) user output, and demonstrate the end-user (analyst) aspect of “reversing” or “backing into” a high scoring claim, in order to understand why it was detected and identified as likely to be inappropriate or inaccurate, or potentially fraudulent. Additional functionalities also provide for linking with prepackaged claims query modules, for example through hyperlinks or pull-down menus, and allowing for capture of review decisions.

Thus, whereas FIG. 4 provides the original claim information (and possibly derived fields like the observed length of stay), FIG. 5 provides the risk scoring, and explains the reasons why a particular score was assigned. In a scale between 1 and 1000, for example, values above a threshold range (e.g., of about 800-900) could be of interest. Underneath the score in the results page layout of FIG. 5, the rational fields or score reasons are listed (e.g., by decreasing relative contribution), in order to determine whether a particular claim requires additional examination or analysis.

In this particular example, several parameters are specific to the score reasons, and are listed to better understand why this claim stood out from the others. For example, the first score reason is related to the strength of “primary-ness” of the secondary diagnoses, in comparison with that of the primary diagnosis. In particular, the average primary-ness of the secondary diagnoses is about 50%, whereas that of the primary diagnosis is only about 33%.

Generally, “primary-ness” relates to the track record for a particular diagnosis code being placed in the primary or principal position in a particular claim data set, as opposed to a secondary or other (not primary) position. For example, there may be a more appropriate secondary diagnosis in the claim, which would “cause” or correlate with a different (e.g., DRG or MS-DRG) coding with a lower (or different) relative weight, when used in place of the original primary diagnosis. In addition, there may be a number of different secondary diagnoses available with more appropriate relative weights, either within the claim data set or absent from the claim data, but identified within the grouper hierarchy. One or more secondary diagnoses may also have an average length of stay that aligns more closely with the actual observed value.

The second reason picks up on the fact that the observed LOS differs from the average length of stay (ALOS), as defined for this particular (e.g., DRG or MS-DRG) code. In addition, some of the secondary diagnoses yield a much closer average length of stay, as obtained by regrouping to another code, and compared to the actual observed value.

The third reason is based on instability in the procedures. In particular, although the proposed procedure switch may not necessarily be ideal, switching procedure codes may nonetheless suggest a degree of misalignment between the coded procedures and the corresponding diagnoses, as described in the claim data set.

More broadly, one idea behind switching diagnoses is based on sensitivity analysis; that is, examining how a system (for example, a particular grouper method) reacts to perturbations. In other words, the approach essentially “shakes” the grouper decision tree, and uses the basic mechanics behind the grouper to determine which claims are relatively stable, and which are not.

With respect to perturbation analysis, the primary diagnosis is a typically key element of claim coding, because the primary diagnosis assigns the major diagnostic category, which represents the first (major or primary) set of branches in the decision tree. Using the secondary diagnoses available on the claim, one can pick up detection patterns including validity of the primary diagnosis, and changes in relative weight caused by moving secondary diagnoses into the primary position. In addition, a substantially shorter (or longer) than usual length of stay, as compared to the average for the assigned DRG or MS-DRG code, may also suggest that one or more secondary diagnoses would be more appropriate in the primary position.

Procedure switching looks for procedures that are closely associated with the “most appropriate” procedure; that is, the procedure that “most associates with” the primary and secondary diagnosis codes, based on position within the claim's coding scheme and from the grouper hierarchy. In particular, procedure switching may indicate a significant change in relative weight when a given (e.g., DRG or MS-DRG) coding is impacted (or switched) by changing out one or more of the procedures listed in the claim data.

Identifying a more “optimal” procedure may include aligning the procedure with both primary and secondary diagnosis codes in the claim data; that is, finding a procedure that is associated with one or more of diagnosis codes based on the grouper hierarchy, either with or without respect to the relevant major diagnostic categories. Once alternate diagnoses are identified based on the selected procedure, a length of stay analysis can also be performed, as described above for procedure switching, where the idea is to match the corresponding length of stay for the alternate diagnoses with the observed length of stay in the original claim data.

Again, the “primary” procedure is identified as the one that “causes” the DRG (or other) claim coding, based on position in the grouper hierarchy. As opposed to switching the primary and secondary diagnoses, selected “alternate” procedures need not necessarily be found in the original claim data, but may instead be identified via a lookup table containing similar or closely related procedures, for example as provided by subject matter experts familiar with the grouper operation.

For provider-centric analysis, benchmarks can be established at the DRG or MS-DRG (grouper or coding) level, and comparisons may be performed across hospitals and other health care facilities. For example, DRG weights can be normalized for each of a plurality of DRG assignments, for each of a plurality of providers, on a provider/DRG basis (that is, one normalized value for each provider, for each DRG). This focus on DRG-type hospital (provider) measures allows for fairly dynamic claim-level metrics. In contrast, a single claim usually won't move the needle very much for metrics that summarize only at the provider level, as opposed to DRG-type (group level) hospital and facility level components, which respond more to the contribution of a single claim.

Thus, even some nominally provider-level behaviors can still be captured at the individual claim level, using special accommodations. In particular, claim data can be normalized by the DRG-type coding, and identified based on complication/comorbid (CC/MCC) factors adjusted for low claim volume, without necessarily summarizing across all possible codes.

In this model, individual claims can be identified by scoring selected DRG assignments, for individual providers. For example, a selected DRG assignment of one provider may be assigned a relatively high risk score if it includes one or more complication/comorbidity factors that are not commonly present in the same DRG assignments for other providers. For example, the complication/comorbidity factor may be present in substantially less than half of the corresponding DRG assignments for other providers, or it may be less common for other providers than for the selected provider. In either case, the result can be a higher relative weighting for the selected DRG assignment, as compared to the normalized values for other providers.

This approach applies not only to complication/comorbid bias based on historical data for other providers, as compared to selected DRG assignments of a particular provider, but also length of stay and readmission/transfer analysis (e.g., transfer rate, time to readmission, patient-based repetitiveness, and length of stay differentiation). While overuse of CC/MCC coding may be identified at the provider level, moreover, the presence or absence of CC/MCC factors in a particular set of claim data can also be used as one input to the overall risk scoring algorithm, when evaluated at the DRG or MS-DRG (group) level.

While other methods may look for unusually short length of stay values, moreover, it can also be interesting to include historical data and trends for the observed length of stay, based on individual claim coding (that is, at the DRG or MS-DRG and provider level). Readmissions and transfers (as well as their direct relation to observed length of stay values) are defined through an individual patient's claim history, for example using a benchmark of readmission within 48 hours.

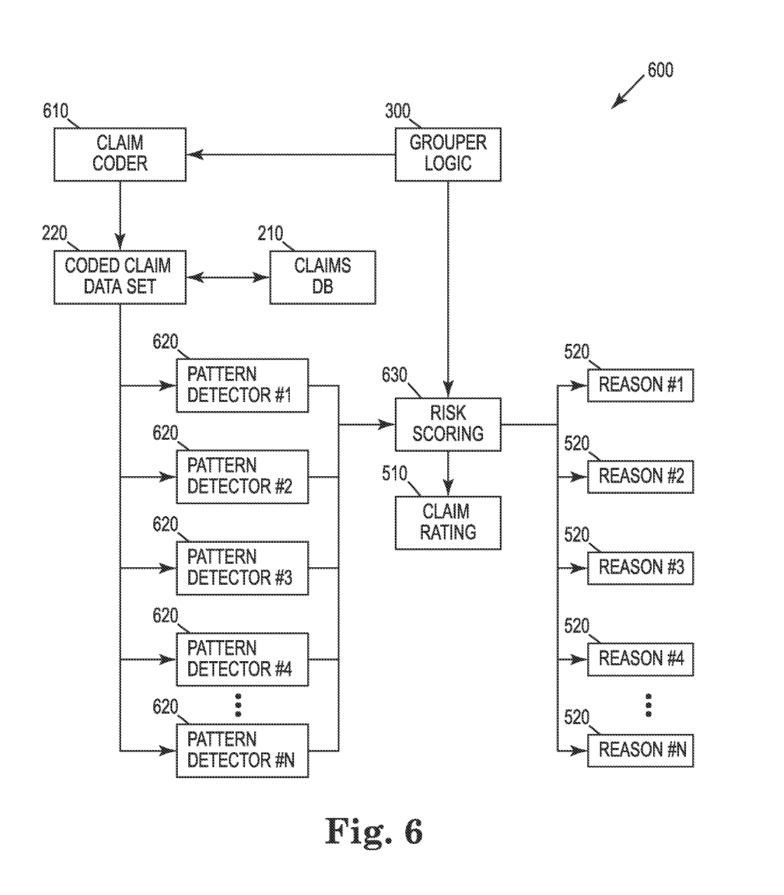

FIG. 6 is a block diagram illustrating a generalized procedure 600 for claim rating and risk scoring. As shown in FIG. 6, a number of claim data sets (or claims 220 are generated by claim coder 610, using grouper logic 300. Individual claims 220 are stored in database 210, and input (e.g., in parallel or series) to pattern detectors and analysis modules 620, in order to perform primary and secondary diagnosis swapping, procedure swapping, length of stay analysis, complication/comorbidity analysis, and other risk scoring algorithm components, as described above.

Results from the individual pattern detector/analysis modules 620 are input to a risk scoring system 630 and aggregated to generate an overall claim rating output, such as risk score field 510. The individual contributions to the claim rating can be described in basis or rationale fields 520, which explain the various reasons for assigning a particular score, and may be ranked according to relative contribution as described above with respect to FIG. 5.

Scoring system 630 can be configured to take into account the same grouper logic 300 used by claim coder 610. Thus, risk scoring and claim rating are performed according to the same diagnosis and procedure mapping (or coding hierarchy) that is used to generate the original coded claims 220, using the same relative weights and payment basis.

FIG. 6 highlights the value of combining the results from a number of individual pattern detector modules 620. In one example, automation of this analytic exploration is utilized to find “hot spots,” which are associated with higher risk scoring and claim rating, as expressed in risk score field or rating output 510. The complementary or “sister” picture of score reasons 520 is provided to show how the different pattern detectors 620 can be backed into these reasons at the time of review. This aspect of risk scoring system 630 may be missed by other modeling techniques, and not available to help end users (i.e., reviewers of individual scored claim data sets or transactions) understand what caused a claim to score high, for either supervised or unsupervised approaches (or both). In addition to raw scoring, the contribution of each pattern detector module 620 can also be described in “score reasons” or rationale fields 520, increasing downstream analysis options and contributing to the richness of the overall review process.

More generally, there are a number of important considerations in determining a claim rating or risk (fraud detection) score. These include, but are not limited to:
Developing synergies by combining results from different analysis modules (e.g., pattern detectors 620), in order to capture significant non-linear interactions between different inputs (e.g., RESULT>INPUT_{—}1+INPUT_{—}2).
Balance aggregation or “mashing” of inputs against the need for the end-user (or claim reviewer) to understand how the different pattern detectors contribute to the overall claim rating or risk score, including methods to “reverse” the risk scoring into a number of individual reasons (e.g., using the reasons in rational fields 520), based on relative contribution to the output (in risk score field 510).

These risk scoring considerations apply both to supervised and unsupervised pattern detection and analysis. While some of these considerations may be somewhat more easily handled or implemented using supervised modeling systems, that is, they can be satisfactorily developed in unsupervised methods as well.

Generally, supervised models are trained on a well-defined history of claim data, in which inappropriate, inaccurate and fraudulent claims have already been identified. This approach has many appealing aspects, including a keen understanding of false positive results.

Unsupervised models are a natural alternative, when the history of fraud and other inappropriate coding is incomplete, or when the data set may be biased or ill-defined. This may be particularly applicable in the health care industry, where complex government regulations, economics, provider preference, patient requests, and even advertising all play a role in treatment.

In this context, unsupervised modeling can utilize data anomaly as an effective proxy for detecting inaccurate coding, inappropriate treatment, and fraud. Generally, cost may or may not provide a lesser control on false positives, but there are benefits in terms of better flexibility in finding and identifying novel data patterns related to inaccurate coding or inappropriate treatment, as well as fraudulent provider behavior.

Based on these considerations, unsupervised modeling and aggregate scoring may be appropriate in the context of claim-centric grouper analysis of health care data, including fraud, waste and abuse detection. In particular, alternate yes-no type (discrete or bivalent) fraud markers may be limited to a relatively small subset of claims that actually get reviewed (e.g., ten percent or less). This lack of good versus bad definition of the transactions' universe contrasts, for example, with the area of credit card fraud, where rarely a fraudulent charge gets missed or goes unreported by account holders.

Even where fraud markers are available in other systems, moreover, they may not capture the exact nature of the problem. That is, they may not be able to identify whether a particular flagged claim is the result of a coding error, a policy/contract level error, a re-bundled, unbundled, re-packaged or re-priced claim, or actual fraud. The present approach also provides machine-learning based scoring and rationale outputs, which more completely describe the claim, and allow for a richer analysis of the reasons why a particular score was assigned.

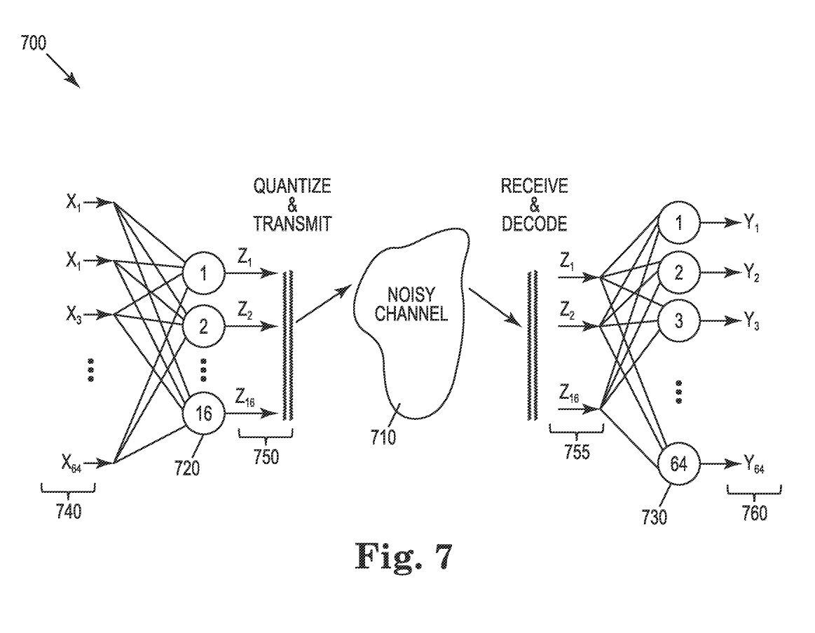

FIG. 7 is a schematic diagram of a representative compression network 700 for use in claim-centric grouper analysis, with transmission through a noisy channel 710. In this particular example, compression network 700 includes a set of (e.g., sixteen) hidden layer nodes 720, which are linked to a set of (e.g., sixty-four) output layer nodes 730 via one or more noisy channels 710.

Hidden layer nodes 720 process a multiplexed or cross-connected input signal 740, for example an 8×8 image of 64 input variables X₁-X₆₄, as shown in FIG. 7. Hidden layer nodes 720 quantize or code variables X₁-X₆₄ of input signal 740 to generate intermediate or internal compressed signal 750 for transmission, for example with sixteen compressed transmission variables Z₁-Z₁₆. In this particular example, compressed internal signal 750 is transmitted through noisy channel (or channels) 710, and received as transmitted signal 755 at output layer nodes 730. Note that received variables Z₁-Z₁₆ in transmitted signal 755 may or may not have exactly the same values as the original compressed variables Z₁-Z₁₆ in transmitted signal 750, due to noise effects in transmission channel 710.

Output layer nodes 730 decode received compressed variable Z₁-Z₁₆ of received signal 755, in order to generate output signal 760. In this particular example, there are sixty-four individual output variables Y₁-Y₆₄ in output 760, corresponding to the original 8×8 image of input variables X₁-X₆₄ in input 740.

Compression network 700 is one of many suitable unsupervised techniques. Its appeal includes the fact it satisfies the previously mentioned characteristics; that is, network 700 astutely manages input interactions, while allowing an end-user or analyst to “back into” the input contributions, when looking at a resulting (e.g., single-valued) risk score or claim rating. In particular, the graphic example of FIG. 7 illustrates a general principle of compression network 700, which streamlines variables X₁-X₆₄ of input signal 740 for transmission over noisy channel 710, in the form of compressed variables Z₁-Z₁₆. Compressed variables Z₁-Z₁₆ are then decoded at the other end, in order to reconstitute the original signal as output variables Y₁-Y₆₄ of output signal 770.

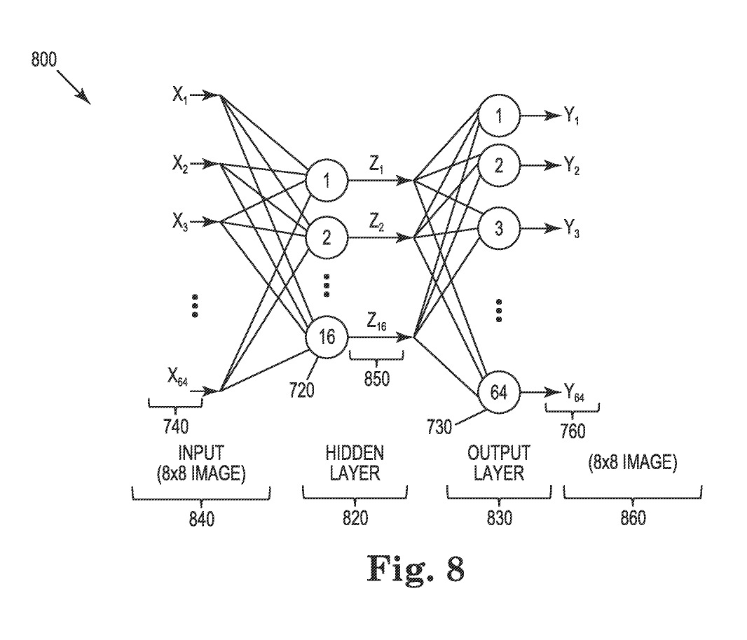

FIG. 8 is a schematic diagram of a representative compression network 800 for use in claim-centric grouper analysis, with “clean” transmission. In this particular example, compression network 800 includes a set of sixteen hidden nodes 720 in hidden layer 820, which are directly linked (no noisy channel) to a set of sixty-four output nodes 730 in output layer 830.

Hidden nodes 720 in hidden layer 820 are used to compress input signal 740, for example in the form of an 8×8 image (reference 840) of sixty-four input variables X₁-X₆₄, in order to generate transmitted signal 850 with (e.g., sixteen) compressed variables Z₁-Z₁₆. Output nodes 730 in output layer 830 are used to decode or decompress variables Z₁-Z₁₆ of compressed signal 850, in order to generate output signal 760, for example in a corresponding 8×8 image (reference 860) of sixty-four output variables Y₁-Y₆₄.

Without the need to transmit through a noisy channel, compression network 800 can still account for inherent noise within compressed variables Z₁-Z₁₆ of transmitted signal 850, and identify this contribution at the time output signal 760 is reconstructed as output image 860 (e.g., by output nodes 730 of output layer 830), while choosing to keep only the essential features of the signal. For a given observation or input image 840 that is run through compression network 800, the more error (or noise) found in output image 860, at the time of signal reconstruction, the greater the likelihood that this particular observation is an outlier.

Thus, the idea of a compression-reconstruction algorithm provides a clean technique to address unsupervised risk scores, which nicely captures the interaction between individual variables while permitting the analysis to readily identify input contributions in the final (single) claim rating. These features are desirable for identifying inaccurate and inappropriate coding, as described above, making the case for using unsupervised models as pattern recognitions modules in the claim-centric grouper analysis.

Suitable score-producing models may also suggest ad-hoc studies to include and go beyond specific rule-based scoring. This approach may be similar to efforts made to find useful rules, but can be more generic, and may be addressed to incorporate the different syntaxes of inaccurate coding, inappropriate care, and intentional fraud. In general, these ad-hoc approaches can also be streamlined into particular pattern detector modules, for identifying aberrant behavior patterns on a claim-centric (claim-by-claim) basis.

The pattern detector modules are fine-tuned and adjusted to generate a suitably low rate of false positives, and combined into a single aggregated risk score or claim rating, based on the observed synergies among the different input components. This also allows for improved workflow efficiencies, including a single queue for further claim review, and fine control of the claim volume fed to the review teams, instead of having to maintain and prioritize tens or even hundreds of individual rules. The ultimate quality of the review process, however, depends on the quality of the pattern detectors used in the computer-based, pre-payment analysis, as described herein.

Generally speaking, aberrant behavior patterns typically describe more diffuse behavior characteristics than rules-based analysis. One idea is thus pushing the envelope by searching for interesting patterns, beyond just the identified and quantified rules, implementing these pattern searches into detector modules, and effectively combining the individual detector modules together into a single aggregated score, producing a powerful detection method.

This approach has distinctly appealing features, including simplification of queue prioritizations and deep yet rapid review procedures, which are not otherwise possible based on existing rule-based techniques. These methods also have applicability to pre-payment and pre-adjudication workflows, at the claim-centric level of individually coded claim data and transactions.

The claim-centric grouper techniques described here can also be coordinated with other analysis procedures, both rules-based and model-based. Additional benefits of risk-based claim scoring include complementarity, with respect to existing rules-based analysis, by using pattern detectors either instead of, or in combination with, other techniques. While the system of pattern detector modules may be less numerous than the corresponding set of rules, moreover, it may nonetheless generate a broader and deeper analysis spectrum. A broader arsenal or “tool belt” of anti-fraud and error detection techniques, as described here, allows the analysis to be adapted to a broader range of different situations, including applications across different working groups with different workflows, different views and different approaches to the basic problem of grouper analysis.

Use of an aggregated (e.g., single) risk score in combination with the scoring reasons also facilitates generation of a single pre-adjudication or pre-payment analysis queue, without additional prioritization management, and provides for tight throughput control based on a “single faucet” model. With fewer specific rule-based criteria, the analysis is also more easily transferrable to other transaction realms, including not only a wide range of DRG and MS-DRG based grouper hierarchies, but also non-DRG based systems. Fewer full-time equivalent (FTE) hours are needed for maintenance and operation, and the system provides rapid adaptability and response to complex shifts in claim coding practice, in order to develop corresponding claim patterning to detect inaccurate coding, inappropriate care, and fraudulent provider practices.

In terms of production claims throughput, the risk-based claim scoring techniques described here provide detailed engineering solutions directed to specific issues including error correction and fraud detection, and can be inserted into corresponding (specific) places in the throughput chain. These case management tools can also be applied to “unscrubbed” or raw-form claim data in order to facilitate decision making at the pre-payment stage, for example using action-directed output flags for reporting or further claim processing, or to stop payment on a claim, based on the risk score. Risk scoring can also be used at the reconsideration and appeal stage, and claim data can be passed or checked for rule exclusions, for example using provider, client, or practice area-specific scoring criteria to allow (or pay) a claim, to partially or fully deny (not pay) a claim, or to generate a medical record request for additional information related to the claim. Performance monitoring and other reporting can also be generated, for example using corresponding provider, client, and/or practice area categories, and/or based on other criteria such as geography, patient demographics, and severity or complication/comorbidity and major complication/comorbidity factors.

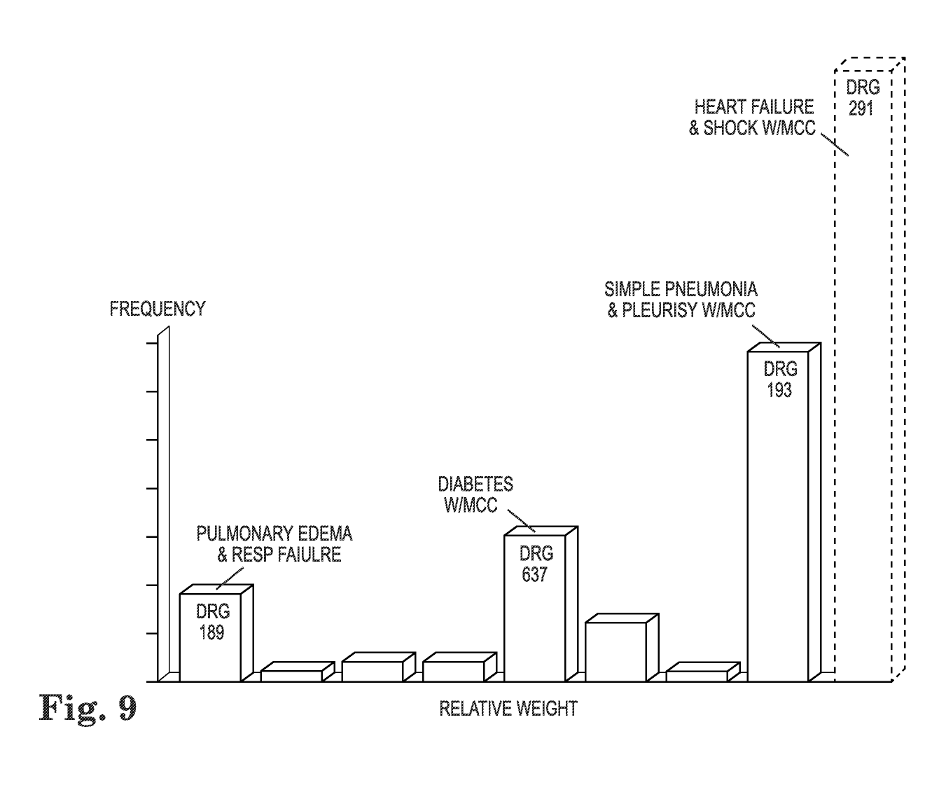

FIG. 9 is a histogram showing the results of a perturbation-based claim-centric grouper analysis, as applied to a set of representative claims related to heart failure and shock. As shown in FIG. 9, the x axis (horizontal) is ordered by the relative claim weight, increasing left to right on an arbitrary scale. The y axis (vertical) indicates the number of claims in each coding group after swapping, also on an arbitrary scale. The original distribution is shown in dashed lines.

In this particular example, a substantial number of claims are regrouped from heart failure & shock, with MCC (DRG 291), to simple pneumonia & pleurisy, also with MCC (DRG 193). Additional claims are shifted to diabetes with MCC (DRG 637), pulmonary edema & respiratory failure (DRG 189), and other grouper codes.

Generally, the claims are re-coded based on a search for more appropriate procedures and diagnoses, but may also be analyzed with respect to the resulting drop (or other change) in relative weight. In particular, the analysis is directed to perturbing or “shaking” the grouper decisions for the selected claims, for example by replacing the primary diagnosis with one or more of the secondary diagnoses in the claim data, or by procedure swapping. Then the original (same) grouper code is rerun, to see whether the individual claims end up with different relative weights.

In this particular example, the highest absolute numbers of “regrouped” claims land in simple pneumonia & pleurisy (DRG 193), which corresponds to a relatively minimal drop in relative weight. This may be considered a relatively conservative result, but even a small change in relative weight may be significant, where large numbers of claims are involved. In addition, other claims from the original group (DRG 291) experience a much higher drop (e.g., to DRG 637 or DRG 189, with even lower relative weights), and this may indicate a higher risk of inaccurate coding, or an inappropriate level of care.

For any inpatient, outpatient, or other health care claims, there is a distinction between coding correctness and financial compensation. In particular, where the focus is primarily on optimizing DRG, MS-DRG, and other coding-based payments, both known and unknown loopholes may be exposed in the grouper hierarchy. Other potential errors and gaming strategies are also considered, including readmissions, transfers, and outlier and disproportionate share payments. Nonetheless, coding correctness and appropriateness of care may still be emphasized over correctness of reimbursement, particularly where the latter may also be related to contract and policy terms.

Combination of different pattern detectors or analysis modules into a single score also addresses issues of queue prioritization across different detector systems. The fact that the pattern detector modules may be less tightly defined than rules-based identification methods allows them to be more easily carried over to different claim streams, with different coding schemes and grouper hierarchies. The use of unsupervised detection modules and a single-score based output (with supporting reasons and rationale) also allows for a more flexible response to novel fraud patterns and other inaccurate or inappropriate coding practices, streamlining staffing needs by placing substantially less burden on maintenance and operation, as compared to other systems with hundreds or thousands of individual rules, which may be in constant flux.

The analysis techniques described here are complementary to these existing systems, and not exclusive. A full arsenal for fraud detection and identification of inaccurate or inappropriate health care claim coding may include all three types of tools, including rules-based analysis, aberrant behavior pattern recognition, and risk scoring. Linkage analytics may also be utilized, as representative of a distinct family of techniques.

While these techniques are designed to encompass pre-payment and pre-adjudication claims processing, moreover, they may also be employed in a retro-active validation or post-payment analysis. Recurrent scoring techniques can also be utilized, as deployed in either a pre-payment implementation or post-payment mode, or in a combination of pre-payment and post-payment analysis. The techniques herein can also be applied to different versions of the various DRG and MS-DRG grouper hierarchies, and to non-DRG based health care reimbursement programs, for example per diem, per stay, or percentage charge systems. Interactions with other data sources are also encompassed, including outpatient and ambulatory claim systems, and pharmacy, laboratory, and other professional claim analysis.

While this invention has been described with reference to exemplary embodiments, it will be understood by those skilled in the art that various changes can be made and equivalents may be substituted, without departing from the spirit and scope of the invention. In addition, modifications may be made to adapt the teachings of the invention to particular situations and materials, without departing from the essential scope thereof. Thus, the invention is not limited to the particular examples that are disclosed herein, but encompasses all embodiments falling within the scope of the appended claims.

1. A computer implemented method of health care claim analysis, the method comprising:
storing a claim data set in a computer database, the claim data set comprising patient information and a DRG assignment based on at least a primary diagnosis code and one or more associated procedure codes;
determining a nominal DRG weight for the claim data set with a processor in communication with the computer database, the nominal DRG weight based at least in part on the primary diagnosis code and the associated procedure code;
looking up an alternate procedure code in the database;
determining an alternate DRG weight for the claim data set by swapping the associated procedure code and the alternate procedure code with the processor, wherein the alternate DRG weight is based at least in part on the primary diagnosis code with the alternate procedure code in place of the associated procedure code; and
outputting a claim score to a user interface in communication with the processor, wherein the claim score is based at least in part on a difference between the nominal DRG weight and the alternate DRG weight.

2. The method of claim 1, wherein the alternate procedure code is selected based on similarity to the associated procedure in a grouper hierarchy for coding the claim data set.

3. The method of claim 2, wherein determining an alternate DRG weight for the claim data set comprises swapping each of the associated procedure codes with a similar procedure code in the grouper hierarchy.

4. The method of claim 2, wherein the alternate procedure code is associated with the primary diagnosis code in the grouper hierarchy.

5. The method of claim 2, wherein the alternate procedure code is associated with an alternate diagnosis code different from the primary diagnosis code in the grouper hierarchy.

6. The method of claim 5, wherein determining the alternate DRG weight comprises swapping the primary diagnosis code with the alternate diagnosis code, and wherein the alternate DRG weight is based at least in part on the alternate diagnosis code in place of the primary diagnosis code.

7. The method of claim 1, further comprising outputting a reason for the claim score to the user interface, wherein the reason describes the alternate procedure code and the difference between the nominal and alternate DRG weights.

8. The method of claim 1, wherein the alternate procedure code is absent from the claim data set.

9. The method of claim 1, further comprising identifying a complication or comorbidity factor associated with the primary diagnosis code in the grouper hierarchy, and adjusting the claim rating based on presence or absence of the complication or comorbidity factor in the claim data set.

10. The method of claim 1, wherein the diagnosis group data comprise one or more secondary diagnosis codes related to the patient data, and further comprising:
swapping the primary diagnosis code and one or more of the secondary diagnosis codes with the processor to define a drop in the nominal DRG weight; and
aggregating the drop in the nominal DRG weight into the claim rating, wherein the claim rating depends both on the difference between the nominal DRG weight and the alternate DRG weight obtained by swapping the primary and alternate diagnosis codes and the aggregated drop in the nominal DRG weight obtained by swapping the primary and secondary diagnosis codes.

11. The method of claim 10, wherein the diagnosis group data comprise a plurality of secondary diagnosis codes, and wherein the drop in the nominal rating is aggregated based on swapping the primary diagnosis code with each of the secondary diagnosis codes in series.

12. The method of claim 11, further comprising adjusting the aggregated drop based on a number of the secondary diagnosis codes.

13. The method of claim 1, wherein the claim data set includes an observed length of stay, and the method further comprising adjusting the claim rating based on a comparison between the observed length of stay and an average length of stay for the primary diagnosis code.

14. The method of claim 13, further comprising outputting a secondary diagnosis code to the user interface, wherein the secondary diagnosis code has an average length of stay that corresponds more closely to the observed length of stay than an average length of stay of the primary diagnosis code.

15. The method of claim 14, further comprising ranking reasons for the claim rating for output to the user interface based on relative contribution, the reasons selected from the difference between the nominal DRG weight and the alternate DRG weight obtained by swapping the associated and alternate procedure codes, a drop in the nominal DRG weight obtained by swapping the primary and secondary diagnosis codes, and a comparison between the observed length of stay and the average length of stay for the primary diagnosis code.

16. A computer implemented system for health care claim analysis, the system comprising:
a database comprising memory configured for storing claim data, the claim data comprising patient information and a related diagnosis group assignment based on at least a primary diagnosis code, a secondary diagnosis code and a procedure code;
a lookup table for identifying an alternate procedure code, wherein the alternate procedure code is associated with the procedure code in a grouper hierarchy used for generating the diagnosis group assignment;
a processor in communication with the database, the processor configured to determine a difference between a nominal claim weight for the diagnosis group assignment based on the primary diagnosis code and an alternate claim weight for the diagnosis group assignment based on the alternate diagnosis code; and
a user interface in communication with the processor, the user interface configured to output a claim score based at least in part on the difference between the nominal and alternate claim weights.

17. The system of claim 16, wherein the alternate procedure code is associated with the primary diagnosis code in the diagnosis group assignment generated by the grouper hierarchy.

18. The system of claim 17, wherein the alternate procedure code is associated with an alternate diagnosis code in the diagnosis group assignment generated by the grouper hierarchy, the alternate diagnosis code different from the primary diagnosis code.

19. The system of claim 18, wherein the primary diagnosis code and the alternate diagnosis code share a major diagnostic category in the grouper hierarchy.

20. The system of claim 18, wherein the primary diagnostic code and the alternate diagnostic code have different major diagnostic categories in the grouper hierarchy.

21. The system of claim 16, wherein the processor is further configured to aggregate the difference between the nominal and alternate claim weights by swapping the primary and secondary diagnosis codes.

22. The system of claim 21, wherein the processor is configured to aggregate the difference between the nominal and alternate claim weights by swapping the primary diagnosis code with a plurality of secondary diagnosis codes in series.

23. The system of claim 16, wherein the processor is configured to adjust the claim score based on presence of a complication/comorbid factor in the diagnosis group assignment generated by the grouper hierarchy.

24. The system of claim 23, wherein the presence of the complication/comorbid factor is indicative of bias based on historical data stored in the database, the historical data normalized for a plurality of providers based on the diagnosis group assignment.

25. The system of claim 23, wherein the processor is configured to adjust the claim score based on an observed length of stay for the primary diagnosis, as compared to an average length of stay for the secondary diagnosis.
